(19) United States
(12) Patent Application Publication
(10) Pub. No.: US 2014/0205845 A1
(43) Pub. Date: Jul. 24, 2014

(54) STABILIZATION AGENTS FOR TRANSPARENT CONDUCTIVE FILMS

(71) Applicant: Carestream Health, Inc., Rochester, NY (US)

(72) Inventors: James B. Philip, JR., Fort Myers, FL (US); Chaofeng Zou, Maplewood, MN (US)

(21) Appl. No.: 14/103,102

(22) Filed: Dec. 11, 2013

Related U.S. Application Data
(60) Provisional application No. 61/754,124, filed on Jan. 18, 2013.

(51) Int. Cl. H01B 1/22; H01B 13/00

(52) U.S. Cl. CPC H01B 1/22; H01B 13/00
USPC 428/457; 427/108

(57) ABSTRACT

Certain phenolic compounds have been found to provide anti-corrosion properties when incorporated into silver nanowire containing films. The effectiveness of such compounds may be enhanced by their introduction into a layer disposed adjacent to a silver nanowire containing layer.

### CROSS-REFERENCE TO RELATED APPLICATIONS

This application claims the benefit of U.S. Provisional Application No. 61/754,124, filed Jan. 18, 2013, entitled STABILIZATION AGENTS FOR TRANSPARENT CONDUCTIVE FILMS, which is hereby incorporated by reference in its entirety.

### BACKGROUND

Transparent and conductive films (TCF) have been used extensively in recent years in applications such as touch panel displays, liquid crystal displays, electroluminescent lighting, organic light-emitting diode devices, and photovoltaic solar cells. Indium tin oxide (ITO) based transparent conductive film has been the transparent conductor-of-choice for most applications due to its high conductivity, transparency, and relatively good stability. However, indium tin oxide based transparent conductive films have limitations due to the high cost of indium, the need for complicated and expensive vacuum deposition equipment and processes, and indium tin oxide's inherent brittleness and tendency to crack, especially when it is deposited on flexible substrates.

Two of the most important parameters for measuring the properties of transparent conductive films are total light transmittance (% T) and film surface electric conductivity. Higher light transmittance allows clear picture quality for display applications, higher efficiency for lighting and solar energy conversion applications. Lower resistivity is most desirable for most transparent conductive film applications in which power consumption can be minimized. Therefore, the higher the T/R ratio of the transparent conductive films is, the better the transparent conductive films are.

U.S. Patent Application Publication 2006/0257638A1 discloses a transparent conductive film comprising carbon nanotubes (CNT) and vinyl chloride resin polymer binder.

U.S. Pat. No. 8,049,333 and U.S. Patent Application Publication 2008/0286447A1 disclose a transparent conductive film in which silver nanowires are deposited onto a substrate to form a bare nanowire network followed by overcoating the silver nanowire network with a polymer matrix material to form a transparent conductive film. The polymer materials such as polyacrylates and carboxyl alkyl cellulose ether polymers were suggested as useful materials for the matrix.

U.S. Patent Application Publication 2008/0286447A1 discloses the use of aromatic triazoles and other nitrogen containing compounds as corrosion inhibitors for silver nanowire based transparent conductors. Long chain alkylthio compounds have also been disclosed as useful corrosion inhibitors.

U.S. Patent Application Publication 2008/0292979A1 discloses a transparent conductive film comprising silver nanowires, or a mixture of silver nanowires and carbon nanotubes. The transparent conductive network is formed either without polymer binder or in a photoimageable composition. The transparent and conductive films were coated on both glass and polyethylene terephthalate (PET) supports.

U.S. Pat. No. 8,052,773 discloses a transparent conductive film which is formed from coating of silver nanowires to form a network followed by overcoating with a layer of urethane acrylate polymer.

U.S. Patent Application Publication 2011/0024159A1 discloses use of corrosion inhibitors in an overcoat layer of a transparent conductive film.

PCT Patent Publication WO 2011/115603A1 discloses anticorrosion agents comprising 1,2-diazine compounds for use in transparent conductive films.

U.S. Patent Application Publication 2010/0307792A1 discloses addition of coordination ligands with silver nanowire aqueous dispersion to form sediments followed by separation of such sediments from the supernatant containing halide ions before apply such silver nanowire dispersion in the coating and formation of the transparent conductive film.

EP Patent Application Publication No. EP2251389A1 discloses a silver nanowire (AgNW) based ink formulation in which various aqueous silver complex ions were added into silver nanowire based ink in a ratio of complex ion to AgNW of no more than 1:64 (w:w).

### SUMMARY OF THE INVENTION

Certain phenolic compounds are particularly useful as anticorrosion agents for the stabilization of a network of silver nanowire-based transparent conductive films toward the undesirable reaction of such conductive films with corrosive agents such as hydrogen sulfide.

We have discovered that the effectiveness of such phenolic compounds may be enhanced by their introduction in at least one coating mix for at least one layer disposed adjacent to the at least one layer comprising silver nanowires. Such a layer might be an overcoat or topcoat layer, if disposed on the at least one layer comprising silver nanowires. Such an overcoat or topcoat layer may, for example, be thermally cured or UV cured. Alternatively, such a layer might be a primer or undercoat layer, if disposed between the at least one layer comprising silver nanowires and the transparent support. Or the phenolic compounds might be included in layers both above and below the at least one layer comprising silver nanowires. In any of these cases, the phenolic compounds may, optionally, also be added to at least one of the layers comprising silver nanowires.

At least a first embodiment provides a transparent conductive article comprising a transparent support; at least one first layer disposed on the transparent support, the at least one first layer comprising a network of silver nanowires dispersed within a polymer binder; and at least one second layer disposed on the at least one first layer, the at least one second layer comprising at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom.

In at least some such embodiments, the at least one first layer may further comprise one or more phenolic compounds as described above.

At least a second embodiment provides a transparent conductive article comprising a transparent support; at least one first layer disposed on the transparent support, the at least one first layer comprising at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom; and at least one second layer disposed on the at least one first layer, the at least one second layer comprising a network of silver nanowires dispersed within a polymer binder.

In at least some such embodiments, the at least one second layer may further comprise one or phenolic compounds as described above.

At least a third embodiment provides a transparent conductive article comprising a transparent support; at least one first layer disposed on the transparent support; at least one second layer disposed on the at least one first layer, the at least one second layer comprising a network of silver nanowires dispersed within a polymer binder; at least one third layer disposed on the at least one second layer, the at least one third layer comprising at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom.

In at least some such embodiments, the at least one second layer may further comprise one or more phenolic compounds as described above.

At least a fourth embodiment provides methods comprising applying at least one first coating mixture onto a transparent support to form at least one first coated layer, the at least one first coating mixture comprising silver nanowires and at least one polymer binder; and applying at least one second coating mixture onto the at least one first coated layer to form at least one second coated layer, the at least one second coating mixture comprising at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom.

In at least some such embodiments, the at least one first coating mixture may further comprise one or more phenolic compounds as described above.

At least a fifth embodiment provides methods comprising applying at least one first coating mixture onto a transparent support to form at least one first coated layer, the at least one first coating mixture comprising at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom, and applying at least one second coating mixture onto the at least one first coated layer, the at least one second coating mixture comprising silver nanowires and at least one polymer binder.

In at least some such embodiments, the at least one second coating mixture may further comprise one or more phenolic compounds as described above.

At least a sixth embodiment provides a transparent conductive article comprising a transparent support; at least one first layer disposed on the transparent support, the at least one first layer comprising silver nanowires dispersed within at least one polymer binder, and at least one first phenolic compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom. In some cases, the at least one first layer comprises the at least one first phenolic compound. In other cases, the transparent conductive article comprises at least a second layer adjacent to the at least one first layer, where the at least one second layer comprises the at least one first phenolic compound. In at least some cases, both the at least one first layer and the at least one second layer comprise the at least one first phenolic compound.

### DESCRIPTION

All publications, patents, and patent documents referred to in this document are incorporated by reference in their entirety, as though individually incorporated by reference.

U.S. Provisional Application No. 61/754,124, filed Jan. 18, 2013, entitled STABILIZATION AGENTS FOR TRANSPARENT CONDUCTIVE FILMS, is hereby incorporated by reference in its entirety.

### DEFINITIONS

The terms “conductive layer” or “conductive film” refer to the network layer comprising silver nanowires dispersed within a polymer binder.

The term “conductive” refers to electrical conductivity.

The term “article” refers to the coating of a “conductive layer” or “conductive film” on a support.

The terms “coating weight,” “coat weight,” and “coverage” are synonymous, and are usually expressed in weight or moles per unit area such as g/m² or mol/m².

The term “transparent” means capable of transmitting visible light without appreciable scattering or absorption.

“Haze” is wide-angle scattering that diffuses light uniformly in all directions. It is the percentage of transmitted light that deviates from the incident beam by more than 2.5 degrees on the average. Haze reduces contrast and results in a milky or cloudy appearance. Materials having lower haze percentages appear less hazy than those having higher haze percentages.

The term “organic solvent” means “a material, liquid at use temperature, whose chemical formula comprises one or more carbon atoms.”

The term “aqueous solvent” means a material, liquid at use temperature, whose composition in a homogeneous solution comprises water in the greatest proportion (i.e., at least 50 per cent water by weight).

The term “water soluble” means the solute forms a homogenous solution with water, or a solvent mixture in which water is the major component.

The terms “a” or “an” refer to “at least one” of that component (for example, the anticorrosion agents, nanowires, and polymers described herein).

Furthermore, all publications, patents, and patent documents referred to in this document are incorporated by reference herein in their entirety, as though individually incorporated by reference.

### INTRODUCTION

In order for silver based transparent conductors to have practical use it is important that these silver based transparent conductors be stable for a long period when subjected to environmental conditions.

Any atmospheric corrosion due to the reaction of low levels of chemicals in the air may induce undesirable chemical changes at the metal nanowire surface, impacting the conductivity and performance of the metal nanowire based transparent conductors. It is well known that corrosion, or “tarnishing,” may readily occur on silver metal surfaces when exposed to the atmosphere. Without wishing to be bound by theory, one example of such a tarnishing mechanism is sulfidation of silver surface by reaction of hydrogen sulfide with silver:

2Ag+H₂S Ag₂S+H₂

Because the electric conductivity of silver compounds such as silver sulfide is much lower than that of silver metal, silver nanowire based conductors can gradually lose conductivity when exposed to the atmosphere.

In contrast to bare metal wires exposed to the air, silver nanowires in a polymer matrix are more stable since the presence of the polymer slows down the diffusion of hydrogen sulfide (or other corrosive agents) to the silver nanowire surface. Nevertheless, it is important to stabilize the silver nanowire surface to prevent the sulfidation process, even when the nanowires are embedded in a polymer matrix.

It would be useful to find anticorrosion agents for transparent electrically conductive films comprising a network of silver nanowires in polymer binder(s) that can be coated from aqueous or from organic solvents, using common coating techniques

### Silver Nanowires

The silver nanowires are an essential component for imparting electrical conductivity to the conductive films, and to the articles prepared using the conductive films. The electrical conductivity of the silver nanowire based transparent conductive film is mainly controlled by a) the conductivity of a single nanowire, b) the number of nanowires between the terminals, and c) the number of connections and the contact resistivity between the nanowires. Below a certain nanowire concentration (also referred as the percolation threshold), the conductivity between the terminals is zero, as there is no continuous current path provided because the nanowires are spaced too far apart. Above this concentration, there is at least one current path available. As more current paths are provided, the overall resistance of the layer will decrease. However, as more current paths are provided, the clarity (i.e., percent light transmission) of the conductive film decreases due to light absorption and back scattering by the nanowires. Also, as the amount of silver nanowires in the conductive film increases, the haze of the transparent film increases due to light scattering by the silver nanowires. Similar effects will occur in transparent articles prepared using the conductive films.

In one embodiment, the silver nanowires have aspect ratio (length/width) of from about 20 to about 3300. In another embodiment, the silver nanowires have an aspect ratio (length/width) of from about 500 to 1000. Silver nanowires having a length of from about 5 μm to about 100 μm (micrometer) and a width of from about 10 nm to about 200 nm are useful. Silver nanowires having a width of from about 20 nm to about 100 nm and a length of from about 10 μm to about 50 μm are also particularly useful for construction of a transparent conductive film.

Silver nanowires can be prepared by known methods in the art. In particular, silver nanowires can be synthesized through solution-phase reduction of a silver salt (e.g., silver nitrate) in the presence of a polyol (e.g., ethylene glycol or propylene glycol) and poly(vinyl pyrrolidone). Large-scale production of silver nanowires of uniform size can be prepared according to the methods described in, e.g., Ducamp-Sanguesa, C. et al, J. of Solid State Chemistry, (1992), 100, 272-280; Sun, Y. et al., Chem. Mater (2002), 14, 4736-4745, Sun, Y. et al., Nano Letters, (2003), 3(7), 955-960; US patent application publication 2012/0063948, published Mar. 15, 2012; US patent application publication 2012/0126181, published May 24, 2012; US patent application publication 2012/0148436, published Jun. 14, 2012; US patent application publication 2012/0207644, published Aug. 16, 2012; and U.S. patent application Ser. No. 13/439,983, filed Apr. 5, 2012, entitled “NANOWIRE PREPARATION METHODS, COMPOSITIONS, AND ARTICLES,” each of which is incorporated by reference in its entirety.

### Polymer Binders

For a practical manufacturing process for transparent conductive films, it is important to have both the conductive components, such as silver nanowires, and a polymer binder in a coating solution. The polymer binder solution serves a dual role, as dispersant to facilitate the dispersion of silver nanowires and as a viscosifier to stabilize the silver nanowire coating dispersion so that the sedimentation of silver nanowires does not occur at any point during the coating process. It is also desirable to have the silver nanowires and the polymer binder in a single coating dispersion. This simplifies the coating process and allows for a one-pass coating, and avoids the method of first coating bare silver nanowires to form a weak and fragile film that is subsequently over-coated with a polymer to form the transparent conductive film.

In order for a transparent conductive film to be useful in various device applications, it is also important for the polymer binder of the transparent conductive film to be optically transparent and flexible, yet have high mechanical strength, good hardness, high thermal stability, and light stability. This requires polymer binders to be used for transparent conductive film to have Tg (glass transition temperature) greater than the use temperature of the transparent conductive film.

Transparent, optically clear polymer binders are known in the art. Examples of suitable polymeric binders include, but are not limited to: polyacrylics such as polymethacrylates (e.g., poly(methyl methacrylate)), polyacrylates and polyacrylonitriles, polyvinyl alcohols, polyesters (e.g., polyethylene terephthalate (PET), polybutylene terephthalate, and polyethylene naphthalate), polymers with a high degree of aromaticity such as phenolics or cresol-formaldehyde (NOVOLACS®), polystyrenes, polyvinyltoluene, polyvinylxylene, polyimides, polyamides, polyamideimides, polyetheramides, polysulfides, polysulfones, polyphenylenes, and polyphenyl ethers, polyurethane (PU), polycarbonates, epoxy, polyolefins (e.g. polypropylene, polymethylpentene, and cyclic olefins), acrylonitrile-butadiene-styrene copolymer (ABS), cellulosics, silicones and other silicon-containing polymers (e.g. polysilsesquioxanes and polysilanes), polyvinylchloride (PVC), polyvinylacetates, polynorbornenes, synthetic rubbers (e.g. EPR, SBR, EPDM), and fluoropolymers (e.g., polyvinylidene fluoride, polytetrafluoroethylene (TFE) or polyhexafluoropropylene), copolymers of fluoro-olefin and hydrocarbon olefin (e.g., LUMIFLON®), and amorphous fluorocarbon polymers or copolymers (e.g., CYTOP® by Asahi Glass Co., or TEFLON® AF by Du Pont), polyvinylbutryals, polyvinylacetals, gelatins, polysaccharides, and starches.

In certain embodiments, in order to disperse and stabilize silver nanowires in polymeric coating solution, the use of polymer binders having high oxygen content is advantageous. Oxygen-containing groups, such as hydroxyl group and carboxylate groups have a strong affinity for binding to the silver nanowire surface and facilitate the dispersion and stabilization. Many oxygen-rich polymers also have good solubility in the polar organic solvents commonly used to prepare organic solvent-coated materials, while other oxygen-rich polymers have good solubility in water or the aqueous solvent mixtures commonly used to prepare aqueous solvent-coated materials.

In certain embodiments, cellulose ester polymers, such as cellulose acetate butyrate (CAB), cellulose acetate (CA), or cellulose acetate propionate (CAP) are superior to other oxygen-rich polymer binders when used to prepare silver nanowire based transparent conductive films that are coated from organic solvents such as 2-butanone (methyl ethyl ketone, MEK), methyl iso-butyl ketone, acetone, methanol, ethanol, 2-propanol, ethyl acetate, propyl acetate, butyl acetate, or mixtures thereof. Their use results in transparent conductive films in which both the optical light transmittance and electrical conductivity of the coated films are greatly improved. In addition, these cellulose ester polymers have glass transition temperatures of at least 100° C. and provide transparent, flexible films having high mechanical strength, good hardness, high thermal stability, and light stability.

The cellulose ester polymers can be present in from about 40 to about 90 wt % of the dried transparent conductive films. Preferably, they are present in from about 60 to about 85 wt % of the dried films. In some constructions, a mixture of a cellulosic ester polymer and one or more additional polymers may be used. These polymers should be compatible with the cellulosic polymer. By compatible is meant that a mixture comprising at least one cellulosic ester polymer and one or more additional polymers forms a transparent, single phase composition when dried. The additional polymer or polymers can provide further benefits such as promoting adhesion to the support and improving hardness and scratch resistance. As above, total wt % of all polymers is from about 40 to about 95 wt % of the dried transparent conductive films. Preferably, the total weight of all polymers is from about 60 to about 85 wt % of the dried films. Polyester polymers, urethanes, and polyacrylics are examples of additional polymers useful for blending with cellulosic ester polymers.

In other embodiments, water soluble polymer binders can also be used, such as polyvinyl alcohol, gelatin, polyacrylic acid, polyimides. Other water dispersible latex polymers can also be used such as polyacrylates and polymethacrylates containing methyl acrylic acid units. Coating from aqueous solutions can benefit the environment and reduce the emission of volatile organic compounds during manufacturing.

The use of water soluble polymers, such as polyvinyl alcohol or gelatin as binders for silver nanowire based transparent conductors results in superior transparent conductive films in which both film transmittance and conductivity are greatly improved. Transparent conductive films prepared using either polyvinyl alcohol or gelatin polymer binders also show excellent clarity, scratch resistance, and hardness when polymer cross linkers are added to the polymer solution. Transparent conductive films prepared according methods disclosed in this application provide transmittance of at least 80% across entire spectrum range of about 350 nm to about 1100 nm, and surface resistivity of 500 ohm/sq or less.

The transparent conductive articles comprising silver nanowires and water soluble polymer binders also show excellent clarity, high scratch resistance, and hardness. In addition, transparent conductive films prepared using these polymer binders have good adhesion to supports comprising polyethylene terephthalate (PET), poly(methylmethacrylate), polycarbonate, and the like, when an appropriate subbing layer is applied between the support and the conductive layer.

The water soluble polymer binders are present in from about 40 to about 95 wt % of the dried transparent conductive films. Preferably, they are present in from about 60 to about 85 wt % of the dried films.

In some constructions, up to 50 wt % of the gelatin or polyvinyl alcohol polymer binder can be replaced by one or more additional polymers. These polymers should be compatible with the gelatin or polyvinyl alcohol polymer binder. By compatible is meant that the all polymers form a transparent, single phase mixture when dried. The additional polymer or polymers can provide further benefits such as promoting adhesion to the support and improving hardness and scratch resistance. Water soluble acrylic polymers are particularly preferred as additional polymers. Examples of such polymers are polyacrylic acid and polyacrylamides, and copolymers thereof. As above, total wt % of all polymers is from about 50 to about 95 wt % of the dried transparent conductive films. Preferably, the total weight of all polymers is from about 70 to about 85 wt % of the dried films.

If desired, scratch resistance and hardness of the transparent conductive films with these polymer binders to the support can be improved by use of crosslinking agents to crosslink the polymer binders. Isocyanates, alkoxyl silanes, and melamines are examples of typical crosslinking agents for cellulose ester polymers containing free hydroxyl groups. Vinyl sulfones and aldehydes are examples of typical crosslinking agents for gelatin binders.

### Stabilization Agents

Stabilization agents are chemical compounds that, when added to the transparent conductive film, improve the stability of the construction with respect to atmospheric corrosion caused by the reaction of oxygen or one or more other chemicals in the atmosphere with one or more components in the film. This reaction results in deterioration of the electric conductivity, optical properties, and/or physical integrity of the film. Stabilization agents should be colorless and odorless when used in the transparent conductive film, and should be stable to the conditions of heat, light, and humidity in the environment where transparent conductive film is used.

However, in practice, many such compounds, when bound to a silver nanowire surface, will drastically reduce the electric conductivity of the resultant conductive film. Without wishing to be bound by theory, the insulating effect of these compounds can apparently prevent electron “flow” at nanowire contact points. Therefore, it is important to identify a class of compounds that will provide anticorrosion protection to transparent conductive film without causing significant reduction in conductivity and other negative effects. Advantageously, delaying introduction of the anticorrosion agents into the conductive nanowire network until after its formation can minimize the destruction of conductive paths in the network.

We have found that phenolic compounds have anti-corrosive and stabilizing effects when incorporated into silver nanowire containing films. It is well know that oxidation of silver nanowire surfaces by oxygen or ozone can play an important role in silver degradation when the silver nanowire surface is exposed to the atmosphere. Without wishing to be bound by theory, in one embodiment:

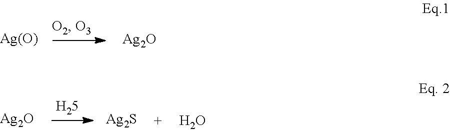

Most phenolic compounds are weak reducing agents but the reaction of these phenolics with oxygen or ozone is thermodynamically more favorable than the reaction of the oxygen or ozone with silver nanowires. Therefore, phenolics or other similar weak reducing agents can act as scavengers for oxidative species, such as those diffused into transparent conductive film layers from the air, and stabilize the silver nanowire-containing transparent conductive film (AgTCF) construction.

In this application, the term “phenolic compound” refers to a compound comprising at least one first aromatic ring, at least one first oxygen atom, and at least one first hydrogen atom bonded to the at least one first oxygen atom, where the at least one first aromatic ring comprises at least one first carbon atom bonded to the at least one first oxygen atom.

In certain embodiments, such phenolic compounds comprise at least one of the following:

SDiPh—bis(4-hydroxyphenyl)sulfone (Alfa Aesar); its structure is shown below:

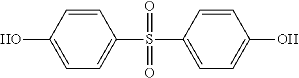 [SMILES: O=S(=O)(c1ccc(O)cc1)c1ccc(O)cc1]

DBP—2,6-di-tert-butylphenol (99%, Aldrich); its structure is shown below:

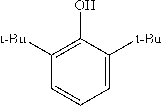 [SMILES: CC(C)(C)c1cccc(C(C)(C)C)c1O]

RA—resorcinol (99%, Aldrich); its structure is shown below:

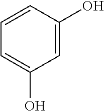

### Coating of the Conductive Films

An organic solvent-based coating formulation for the transparent silver nanowire films can be prepared by mixing the various components with one or more polymer binders in a suitable organic solvent system that usually includes one or more solvents such as toluene, 2-butanone (methyl ethyl ketone, MEK), methyl iso-butyl ketone, acetone, methanol, ethanol, 2-propanol, ethyl acetate, propyl acetate, butyl acetate, ethyl lactate, tetrahydrofuran, or mixtures thereof. An aqueous-based coating formulation for the transparent silver nanowire films can be prepared by mixing the various components with one or more polymer binders in water or in a mixture of water with a water miscible solvent such as acetone, acetonitrile, methanol, ethanol, 2-propanol, or tetrahydrofuran, or mixtures thereof. Transparent films containing silver nanowires can be prepared by coating the formulations using various coating procedures such as wire wound rod coating, dip coating, knife or blade coating, curtain coating, slide coating, slot-die coating, roll coating, or gravure coating. Surfactants and other coating aids can be incorporated into the coating formulation.

In one embodiment the coating weight of the silver nanowires is from about 10 mg/m² to about 500 mg/m². In another embodiment the coating weight of silver nanowires is from about 20 mg/m² to about 200 mg/m². In a further embodiment, the coating weight of silver nanowires is from about 30 mg/m² to about 120 mg/m². A useful coating dry thickness of the transparent conductive coating is from about 0.05 μm to about 2.0 μm, and preferably from about 0.1 μm to about 0.5 μm.

Upon coating and drying, the transparent conductive film should have a surface resistivity of less than 1,000 ohms/sq and preferably less than 500 ohm/sq.

Upon coating, and drying, the transparent conductive film should have as high a % transmittance as possible. A transmittance of at least 70% is useful. A transmittance of at least 80% and even at least 90% are even more useful.

Particularly useful are films with a transmittance of at least 70% and a surface resistivity of less than 500 ohm/sq.

Such transparent conductive films provide transmittance of at least 80% across entire spectrum range of from about 350 nm to about 1100 nm, and surface resistivity of less than 500 ohm/sq.

### Transparent Support

In one embodiment, the conductive materials are coated onto a support. The support may be rigid or flexible.

Suitable rigid substrates include, for example, glass, polycarbonates, acrylics, and the like.

When the conductive materials are coated onto a flexible support, the support is preferably a flexible, transparent polymeric film that has any desired thickness and is composed of one or more polymeric materials. The support is required to exhibit dimensional stability during coating and drying of the conductive layer and to have suitable adhesive properties with overlying layers. Useful polymeric materials for making such supports include polyesters [such as poly(ethylene terephthalate) (PET) and poly(ethylene naphthalate) (PEN)], cellulose acetates and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability. Transparent multilayer supports can also be used.

Coating of the Conductive Films onto a Support

Transparent conductive articles can be prepared by coating the formulations described above onto a transparent support using various coating procedures such as wire wound rod coating, dip coating, knife coating, curtain coating, slide coating, slot-die coating, roll coating, gravure coating, or extrusion coating.

Alternatively, transparent conductive articles can be prepared by laminating the transparent conductive films prepared as described above onto a transparent support.

In some embodiments, a “carrier” layer formulation comprising a single-phase mixture of two or more polymers may be applied directly onto the support and thereby located between the support and the silver nanowire layer. The carrier layer serves to promote adhesion of the support to the transparent polymer layer containing the silver nanowires. The carrier layer formulation can be sequentially or simultaneously applied with application of the transparent conductive silver nanowire layer formulation. It is preferred that all coating be applied simultaneously onto the support. Carrier layers are often referred to as “adhesion promoting layers,” “interlayers,” or “intermediate layers.”

As noted above, in one embodiment the coating weight of the silver nanowires is from about 20 mg/m² to about 500 mg/m². In other embodiments, coating weight of silver nanowires is from about 10 mg/m² to about 200 mg/m². Embodiments wherein the silver nanowires are coated at from about 10 mg/m² to about 120 mg/m² are also contemplated.

Upon coating and drying, the transparent conductive article should have a surface resistivity of less than 1,000 ohms/sq and preferably less than 500 ohm/sq.

Similarly, upon coating and drying on a transparent support, the transparent conductive article should have as high an optical transmittance as possible. A transmittance of at least 70% is useful. A transmittance of at least 80% and even at least 90% are even more useful.

Particularly preferred are articles with a transmittance of at least 80% and a surface resistivity of less than 500 ohm/sq.

### EXEMPLARY EMBODIMENTS

U.S. Provisional Application No. 61/754,124, filed Jan. 18, 2013, entitled STABILIZATION AGENTS FOR TRANSPARENT CONDUCTIVE FILMS, which is hereby incorporated by reference in its entirety, disclosed the following 42 non-limiting exemplary embodiments:

A. A transparent conductive article comprising:

a transparent support;

at least one first layer disposed on the transparent support, the at least one first layer comprising a network of silver nanowires dispersed within at least one polymer binder; and

at least one second layer disposed on the at least one first layer, the at least one second layer comprising at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom.

B. The transparent conductive article of embodiment A, wherein the said at least one first phenolic compound comprises at least one of: bis(4-hydroxyphenyl) sulfone, 2-6-di-tert-butylphenol, or resorcinol.
C. The transparent conductive article of embodiment A, wherein the transparent support is a flexible transparent polymer film.
D. The transparent conductive article of embodiment A, wherein the silver nanowires are present in an amount sufficient to provide a surface resistivity of less than about 1000 ohm/sq.
E. The transparent conductive article of embodiment A, wherein the silver nanowires have an aspect ratio of from about 20 to about 3300.
F. The transparent conductive article of embodiment A, wherein the silver nanowires are present in an amount of from about 10 mg/m² to about 500 mg/m².
G. The transparent conductive article of embodiment A, having a transmittance of at least about 80% across entire spectrum range of from about 350 nm to about 1100 nm and a surface resistivity of 500 ohm/sq or less.
H. The transparent conductive article of embodiment A, wherein the at least one polymer binder comprises at least one water soluble polymer.
J. The transparent conductive article of embodiment H, wherein the at least one water soluble polymer comprises gelatin, polyvinyl alcohol, or mixtures thereof.
K. The transparent conductive article of embodiment J, wherein the at least one polymer binder further comprises up to about 50 wt % of one or more additional water soluble polymers.
L. The transparent conductive article of embodiment K, wherein one or more of the additional water soluble polymers is a polyacrylic polymer.
M. The transparent conductive article of embodiment A, wherein the at least one polymer binder comprises an organic solvent soluble polymer.
N. The transparent conductive article of embodiment M, wherein the organic solvent soluble polymer binder comprises at least one cellulose ester polymer.
P. The transparent conductive article of embodiment M, wherein the organic solvent soluble polymer binder comprises cellulose acetate, cellulose acetate butyrate, or cellulose acetate propionate, or mixtures thereof.
Q. The transparent conductive article of embodiment N, wherein the at least one cellulose ester polymer has a glass transition temperature of at least about 100° C.
R. The transparent conductive article of embodiment M, wherein the at least one polymer binder further comprises up to 50 wt % of one or more additional organic solvent soluble polymers.
S. The transparent conductive article of embodiment R, wherein the one or more of the additional organic solvent soluble polymers is a polyester polymer.
T. A transparent conductive article comprising:

a transparent support;

at least one first layer disposed on the transparent support, the at least one first layer comprising a network of silver nanowires and a polymer binder;

at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom; and
at least one second layer consisting of a transparent polymer.
   U. The transparent conductive article of embodiment T, wherein the said at least one first phenolic compound comprises at least one of: bis(4-hydroxyphenyl) sulfone, 2-6-di-tert-butylphenol, or resorcinol.
   V. The transparent conductive article of embodiment T, wherein the transparent support is a flexible transparent polymer film.
   W. The transparent conductive article of embodiment T, wherein the silver nanowires are present in an amount sufficient to provide a surface resistivity of less than about 1000 ohm/sq.
   X. The transparent conductive article of embodiment T, wherein the silver nanowires have an aspect ratio of from about 20 to about 3300.
   Y. The transparent conductive article of embodiment T, wherein the silver nanowires are present in an amount of from about 10 mg/m² to about 500 mg/m².
   Z. The transparent conductive article of embodiment T, having a transmittance of at least about 80% across entire spectrum range of from about 350 nm to about 1100 nm and a surface resistivity of 500 ohm/sq or less.
   AA. The transparent conductive article of embodiment T, wherein the at least one polymer binder comprises at least one water soluble polymer.
   AB. The transparent conductive article of embodiment AA, wherein the at least one water soluble polymer comprises gelatin, polyvinyl alcohol, or mixtures thereof.
   AC. The transparent conductive article of embodiment AB, wherein the at least one polymer binder further comprises up to about 50 wt % of one or more additional water soluble polymers.
   AD. The transparent conductive article of embodiment AC, wherein one or more of the additional water soluble polymers is a polyacrylic polymer.
   AE. The transparent conductive article of embodiment T, wherein the at least one polymer binder comprises an organic solvent soluble polymer.
   AF. The transparent conductive article of embodiment AE, wherein the organic solvent soluble polymer binder comprises at least one cellulose ester polymer.
   AG. The transparent conductive article of embodiment AE, wherein the organic solvent soluble polymer binder comprises cellulose acetate, cellulose acetate butyrate, or cellulose acetate propionate, or mixtures thereof.
   AH. The transparent conductive article of embodiment AF, wherein the at least one cellulose ester polymer has a glass transition temperature of at least about 100° C.
   AJ. The transparent conductive article of embodiment AE, wherein the at least one polymer binder further comprises up to about 50 wt % of one or more additional organic solvent soluble polymers.
   AK. The transparent conductive article of embodiment AJ, wherein the one or more of the additional organic solvent soluble polymers is a polyester polymer.
   AL. A method comprising:

applying at least one first coating mixture onto a transparent support to form at least one first coated layer, the at least one first coating mixture comprising silver nanowires and at least one polymer binder; and

applying at least one second coating mixture onto the at least one first coated layer to form at least one second coated layer, the at least one second coating mixture comprising at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom.

AM. The method according to embodiment AL, wherein the said at least one first phenolic compound comprises at least one of: bis(4-hydroxyphenyl)sulfone, 2-6-di-tert-butylphenol, or resorcinol.
AN. The method according to embodiment AL, wherein the applying the at least one first coating mixture and the applying the at least one second coating mixture occur simultaneously.
AP. The method according to embodiment AL, further comprising drying the at least one first layer or the at least one second layer or both.
AQ. A method comprising:

applying at least one first coating mixture onto a transparent support to form at least one first coated layer, the at least one first coating mixture comprising and at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom; and

applying at least one second coating mixture onto the at least one first coating layer, the at least one second coating mixture comprising silver nanowires and at least one polymer binder.

AR. The method according to embodiment AQ, wherein the said at least one first phenolic compound comprises at least one of: bis(4-hydroxyphenyl)sulfone, 2-6-di-tert-butylphenol or resorcinol.
AS. The method according to embodiment AQ, wherein the applying the at least one first coating mixture and the applying the at least one second coating mixture occur simultaneously.
AT. The method according to embodiment AQ, further comprising drying the at least one first layer or the at least one second layer or both.

### EXAMPLES

### Materials and Methods

All materials used in the following examples are readily available from standard commercial sources, such as Aldrich Chemical Co. (Milwaukee, Wis.) unless otherwise specified. All percentages are by weight unless otherwise indicated. The following additional methods and materials were used.

CAB 381-20 is a cellulose acetate butyrate resin available from Eastman Chemical Co. (Kingsport, Tenn.). It has a glass transition temperature of 141° C.

CAB 553-0.4 is a cellulose acetate butyrate resin available from Eastman Chemical Co. (Kingsport, Tenn.). It has a glass transition temperature of 136° C.

CYMEL 303 (hexamethoxymethylmelamine) is a liquid crosslinking agent (Cytec Industries, West Paterson, N.J.).

DAROCUR 1173 (2-hydroxy-2-methyl-1-phenyl-propan-1-one, Ciba) is a photoinitiator, with a molecular weight of 164.2 g/mol.

DBP—2,6-di-tert-butylphenol (99%, Aldrich); its structure is shown below:

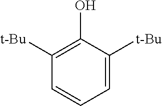 [SMILES: CC(C)(C)c1cccc(C(C)(C)C)c1O]

Mayer Bars are ½ inch diameter Type 303 stainless steel coating rods and are available from R.D. Specialties, Inc. (Webster, N.Y.).

RA—resorcinol (99%, Aldrich); its structure is shown below:

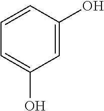

SDiPh—bis(4-hydroxyphenyl)sulfone (Alfa Aesar); its structure is shown below:

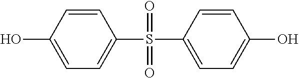 [SMILES: O=S(=O)(c1ccc(O)cc1)c1ccc(O)cc1]

SR399 (dipentaerythritolpentaacrylate, Sartomer) is a clear liquid, with a molecular weight of 525 g/mol; its structure is shown below:

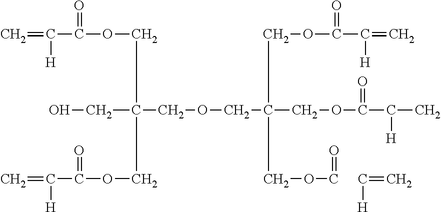

SLIP-AYD® FS 444 (polysiloxane in dipropylene glycol, Elementis) is a liquid additive for increasing surface slip and mar resistance of water borne and polar solvent borne coatings.

### Silver Nanowires

Silver nanowires were prepared according to two procedures. For Example 1 and 2, a procedure similar to Example 13 of U.S. patent application Ser. No. 13/439,983, filed Apr. 5, 2012, entitled “NANOWIRE PREPARATION METHODS, COMPOSITIONS, AND ARTICLES” was followed, using a reaction temperature of 160° C. for 45 min. Silver nanowires so prepared exhibited an average diameter of 54±29 nm, and an average length of 18±14 μm. For Example 3, silver nanowires were prepared according to procedures described in U.S. patent application Ser. No. 14/043,966, “NANOWIRE PREPARATION METHODS, COMPOSITIONS, AND ARTICLES,” filed Oct. 2, 2013, which is hereby incorporated by reference in its entirety. The typical silver nanowires have diameters ranging from 38 nm to 44 nm and range in length from 17 to 25 μm.

### Example 1

### Preparation of Silver Nanowire Coating Dispersion

A CAB polymer premix solution was prepared by mixing 15 parts by weight of CAB 381-20 (cellulose acetate butyrate polymer, Eastman Chemical) with 85 parts by weight of n-propyl acetate (Oxea). The resulting CAB polymer premix solution was filtered prior to use.

17.32 parts by weight of the CAB polymer premix solution was combined with 18.18 parts by weight ethyl lactate (>99.8% purity), 56.16 parts by weight of a 1.85% solids dispersion of silver nanowires in isopropanol, and 8.34 parts by weight of n-propyl acetate (Oxea) to form a silver nanowire coating dispersion at 3.64% solids.

Finished silver solutions were prepared by adding various loadings of bis(4-hydroxyphenyl)sulfone (SDiPh) to aliquots of the masterbatch solution, as shown in Table I. The finished silver nanowire coating dispersions were coated on a lab proofer with a 350 lines per inch (LPI) plate onto 5 mil ESTAR LS polyester supports, and dried at 280° F. for 2 min.

### Preparation of Topcoat Solution

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution, 1405 parts by weight denatured ethanol, 2250 parts by weight of 33 wt % SR399 (dipentaerythritolpentaacrylate, Sartomer) in denatured ethanol, 150 parts by weight of 10 wt % SLIP-AYD FS-444 (polysiloxane in dipropylene glycol ether, Elementis) in denatured ethanol, 435 parts by weight of 31 wt % DAROCUR 1173 (Ciba) in denatured ethanol, and 1027 parts by weight of n-butanol (>98% purity). The topcoat masterbatch solution had 16.0% solids.

### Preparation of the Coated Films

The above topcoat solution was overcoated on the silver nanowire-containing layer with a 450 lines per inch (LPI) plate. The coatings were then dried in an oven at 220° F. for 2 min followed by two pass UV curing with a FUSION 300 UV-H lamp at 20 ft/min speed.

### Evaluation of the Coated Films

Transparent conductive film (TCF) surface resistivity, light transmission, and haze were evaluated at 80° C. and on a lab desktop as outlined below.

80° C. TCF Stability Test

Surface resistivity was measured for the coatings immediately after coating (initial values) with either a RCHEK RC3175 4-point resistivity meter or a DELCOM 707 non-contact conductance monitor. These TCF samples were then placed in a BLUE-M oven with free air flow at 80° C. for 10 days. After the test period, the TCF samples were then checked again to record the change in film resistivity.

Desktop TCF Stability Test

Surface resistivity was measured for the coatings immediately after coating (initial values) with either an RCHEK RC3175 4-point resistivity meter or a DELCOM 707 non-contact conductance monitor. These TCF samples were then placed on lab desktop under 1500-2000 LUX fluorescence light with the TCF side towards the light for 1 and 2 months. After the test period, the TCF samples were then checked again to record the change in film resistivity.

The stability testing results in Table I show both 80° C. stability and desktop stability were improved upon addition of bis(4-hydroxyphenyl)sulfone (SDiPh) directly to the silver nanowire coating dispersion.

TABLE I

| | SDiPh in | | Initial | Total | | Surface Resistivity | Surface Resistivity | Surface Resistivity | Surface Resistivity |
|---|---|---|---|---|---|---|---|---|---|
| | Ag | Ratio of | Surface | light | | Change 80° C. | Change Desktop | Change Desktop | Change Desktop |
| Sample | Solution | wires to | Resistivity | trans. | Haze | t = 10 days | t = 1 month | t = 2 months | t = 3 months |
| # | (wt %) | SDiPh (g/g) | (ohms/sq) | (% T) | (%) | (% change) | (% change) | (% change) | (% change) |
| Com-1-1 | none | | 89 | 88.8 | 2.16 | +164 | +20 | +45 | +75 |
| 1-1 | 0.01 | 106 | 94 | 88.8 | 2.17 | +65 | +4 | +9 | +41 |
| 1-2 | 0.05 | 21 | 112 | 88.8 | 2.20 | +75 | +9 | +11 | +31 |

### Example 2

### Preparation of Silver Nanowire Coating Dispersion

A CAB polymer premix solution was prepared by mixing 10 parts by weight of CAB 381-20 (cellulose acetate butyrate polymer, Eastman Chemical) with 90 parts by weight of isopropyl acetate (>98.6% purity, Aldrich). The resulting CAB polymer premix solution was filtered prior to use.

25.43 parts by weight of the CAB polymer premix solution was combined with 16.96 parts by weight ethyl lactate (>99.8% purity), 45.82 parts by weight of a 1.85% solids dispersion of silver nanowires in isopropanol, and 11.79 parts by weight of isopropyl acetate (>98.6% purity, Aldrich) to form a silver nanowire coating dispersion at 3.39% solids.

Finished silver solutions were prepared by adding various loadings of 2,6-di-tert-butylphenol (DBP) and resorcinol (RA) to aliquots of the masterbatch solution, as shown in Table II. The finished silver nanowire coating dispersions were coated on a lab proofer with a 320 lines per inch (LPI) plate onto 5 mil ESTAR LS polyester supports, and dried at 280° F. for 2 min.

### Preparation of Topcoat Solution

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution, 1125 parts by weight denatured ethanol, 2250 parts by weight of 33 wt % CYMEL 303 (hexamethoxymethylmelamine, Cytec) in denatured ethanol, 150 parts by weight of 10 wt % SLIP-AYD FS-444 (polysiloxane in dipropylene glycol ether, Elementis) in denatured ethanol, 375 parts by weight of 20 wt % p-toluenesulfonic acid (PTSA, Fisher/Univar) in denatured ethanol, and 989 parts by weight of n-butanol (>98% purity). The topcoat masterbatch solution had 16.0% solids.

### Preparation of the Coated Films

The topcoat solution was overcoated on the silver nanowire-containing layer with a lab proofer and a 450 lines per inch (LPI) plate onto 5 mil ESTAR LS polyester supports, and dried at 280° F. for 3 min.

### Evaluation of the Coated Films

The coated films were evaluated using the technique described in Example 1. The stability testing results in Table II show that 80° C. stability and desktop stability were improved upon addition of 2,6-di-tert-butylphenol (DBP) and resorcinol (RA) directly to the silver nanowire coating dispersion.

TABLE II

| | | | | | | | Surface | Surface | Surface | Surface |
|---|---|---|---|---|---|---|---|---|---|---|
| | | | | | | | Resistivity | Resistivity | Resistivity | Resistivity |
| | | | | Initial | Total | | Change | Change | Change | Change |
| | Ratio of | DBP in | RA in | Surface | light | | 80° C. t = 10 | Desktop t = 1 | Desktop t = 2 | Desktop t = 3 |
| Sample | wires to | Agsolution | Agsolution | Resistivity | trans. | Haze | days | month | months | months |
| # | DBP or RA | (wt %) DBP | (wt %) RA | (ohms/sq) | (% T) | (%) | (% change) | (% change) | (% change) | (% change) |
| Com-2-1 | | none | none | 56 | 87.6 | 3.56 | +361 | +13 | +17 | +21 |
| 2-1 | 85 | 0.012 | none | 58 | 87.9 | 4.15 | +215 | +10 | +12 | +8 |
| 2-2 | 21 | 0.050 | none | 55 | 87.7 | 4.67 | +253 | +0 | +2 | +5 |
| 2-3 | 85 | none | 0.012 | 61 | 87.7 | 3.73 | +310 | +16 | +13 | +16 |
| 2-4 | 21 | none | 0.050 | 60 | 87.9 | 3.59 | +327 | +11 | +8 | +15 |

### Example 3

### Prophetic

### Preparation of Silver Nanowire Coating Dispersion

A CAB polymer premix solution is prepared by mixing 10 parts by weight of CAB 381-20 (cellulose acetate butyrate polymer, Eastman Chemical) with 90 parts by weight of isopropyl acetate (>98.6% purity, Aldrich). The resulting CAB polymer premix solution is filtered prior to use.

25.43 parts by weight of the CAB polymer premix solution is combined with 16.96 parts by weight ethyl lactate (>99.8% purity), 45.82 parts by weight of a 1.85% solids dispersion of silver nanowires in isopropanol, and 11.79 parts by weight of isopropyl acetate (>98.6% purity, Aldrich) to form a silver nanowire coating dispersion at 3.39% solids.

The finished silver nanowire coating dispersion is coated on a lab proofer with a 320 lines per inch (LPI) plate onto 5 mil ESTAR LS polyester supports, and dried at 280° F. for 2 min.

### Preparation of Topcoat Solution

A CAB polymer premix solution is prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution is filtered prior to use.

A topcoat masterbatch solution is prepared by adding to 5000 parts by weight of the CAB polymer premix solution, 1125 parts by weight denatured ethanol, 2250 parts by weight of 33 wt % CYMEL 303 (hexamethoxymethylmelamine, Cytec) in denatured ethanol, 150 parts by weight of 10 wt % SLIP-AYD FS-444 (polysiloxane in dipropylene glycol ether, Elementis) in denatured ethanol, 375 parts by weight of 20 wt % p-toluenesulfonic acid (PTSA, Fisher/Univar) in denatured ethanol, and 989 parts by weight of n-butanol (>98% purity). The topcoat masterbatch solution has 16.0% solids.

Finished topcoat solutions are prepared by adding various loadings of one of the stabilizers bis(4-hydroxyphenyl)sulfone (SDiPh), 2,6-di-tert-butylphenol (DBP), or resorcinol (RA) to aliquots of the masterbatch solution, in order to provide 0.06, 0.23, or 0.24 wt % solutions of each of the stabilizers in their respective topcoat solutions, making nine solutions in total.

### Preparation of the Coated Films

The topcoat solutions are overcoated on the silver nanowire-containing layers with a lab proofer and a 450 lines per inch (LPI) plate onto 5 mil ESTAR LS polyester supports, and dried at 280° F. for 3 min.

### Evaluation of the Coated Films

The coated films are evaluated using the technique described in Example 1. The stability testing results show that 80° C. stability and desktop stability are improved upon addition of each of the three stabilizers bis(4-hydroxyphenyl)sulfone (SDiPh), 2,6-di-tert-butylphenol (DBP), and resorcinol (RA), at all three levels tested, relative to control samples that do not contain any of these stabilizers.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A transparent conductive article comprising:
a transparent support;
at least one first layer disposed on the transparent support, the at least one first layer comprising a network of silver nanowires dispersed within at least one polymer binder; and
at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom.

2. The transparent conductive article according to claim 1, wherein the at least one first layer comprises the at least one first phenolic compound.

3. The transparent conductive article according to claim 1, further comprising at least one second layer disposed adjacent to the at least one first layer, wherein the at least one second layer comprises the at least one phenolic compound.

4. The transparent conductive article according to claim 3, wherein the at least one second layer is disposed on the at least one first layer.

5. The transparent conductive article according to claim 3, wherein the at least one second layer is disposed between the transparent substrate and the at least one first layer.

6. The transparent conductive article according to claim 1, wherein the said at least one first phenolic compound comprises at least one of: bis(4-hydroxyphenyl) sulfone, 2-6-di-tert-butylphenol, or resorcinol.

7. The transparent conductive article according to claim 1, having a transmittance of at least about 80% across entire spectrum range of from about 350 nm to about 1100 nm and a surface resistivity of 500 ohm/sq or less.

8. The transparent conductive article according to claim 1, wherein the at least one polymer binder comprises gelatin, polyvinyl alcohol, or mixtures thereof.

9. The transparent conductive article according to claim 1, wherein the at least one polymer binder comprises cellulose acetate, cellulose acetate butyrate, or cellulose acetate propionate, or mixtures thereof.

10. A method comprising:
applying at least one first coating mixture onto a transparent support to form at least one first coated layer, the at least one first coating mixture comprising silver nanowires and at least one polymer binder; and
applying at least one second coating mixture onto the at least one first coated layer to form at least one second coated layer, the at least one second coating mixture comprising at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom.

11. A method comprising:
applying at least one first coating mixture onto a transparent support to form at least one first coated layer, the at least one first coating mixture comprising and at least one first phenolic compound comprising at least one first aromatic ring, at least one first oxygen atom, and at least one first hydrogen atom bonded to the at least one first oxygen atom, wherein the at least one first aromatic ring comprises at least one first carbon atom bonded to the at least one first oxygen atom; and
applying at least one second coating mixture onto the at least one first coating layer, the at least one second coating mixture comprising silver nanowires and at least one polymer binder.
